(19) United States
(12) Patent Application Publication
(10) Pub. No.: US 2026/0112145 A1
(43) Pub. Date: Apr. 23, 2026

(54) DATASET CONSTRUCTION FOR TRAINING MACHINE LEARNING MODELS

(71) Applicant: Samsung Electronics Co., Ltd., Suwon-si (KR)

(72) Inventors: Sumit Jha, Irvine, CA (US); Arshita Gupta, Irvine, CA (US); Tien C. Bau, Irvine, CA (US)

(21) Appl. No.: 19/329,388

(22) Filed: Sep. 15, 2025

Related U.S. Application Data
(60) Provisional application No. 63/709,928, filed on Oct. 21, 2024.

(51) Int. Cl. G06V 10/762; G06N 20/00; G06V 10/25; G06V 10/44; G06V 10/46; G06V 10/74

(52) U.S. Cl. CPC G06V 10/762; G06N 20/00; G06V 10/25; G06V 10/44; G06V 10/462; G06V 10/761

(57) ABSTRACT

A method includes obtaining, using at least one processing device of an electronic device, multiple image frames. The method also includes generating, using the at least one processing device, multiple image crops of at least one of the image frames. Each image crop represents a portion of the associated image frame, and at least some of the image crops form at least a portion of training data for a machine learning model. The method further includes performing, using the at least one processing device, redundancy reduction to at least one of (i) identify a subset of the image frames from which the image crops are generated and (ii) identify a subset of the image crops for inclusion in the training data.

### CROSS-REFERENCE TO RELATED APPLICATION AND PRIORITY CLAIM

This application claims priority under 35 U.S.C. § 119 (e) to U.S. Provisional Patent Application No. 63/709,928 filed on Oct. 21, 2024, which is hereby incorporated by reference in its entirety.

### TECHNICAL FIELD

This disclosure relates generally to machine learning systems and processes. More specifically, this disclosure relates to dataset construction for training machine learning models.

### BACKGROUND

Training a deep neural network or other machine learning model often involves the use of a large amount of training data. The ability to train machine learning models effectively typically depends on the availability of high-quality diverse training data. Often times, large training datasets are collected by scraping data, such as in the form of images or videos, from the Internet.

### SUMMARY

This disclosure relates to dataset construction for training machine learning models.

In a first embodiment, a method includes obtaining, using at least one processing device of an electronic device, multiple image frames. The method also includes generating, using the at least one processing device, multiple image crops of at least one of the image frames. Each image crop represents a portion of the associated image frame, and at least some of the image crops form at least a portion of training data for a machine learning model. The method further includes performing, using the at least one processing device, redundancy reduction to at least one of (i) identify a subset of the image frames from which the image crops are generated and (ii) identify a subset of the image crops for inclusion in the training data.

In a second embodiment, an apparatus includes at least one processing device configured to obtain multiple image frames and generate multiple image crops of at least one of the image frames. Each image crop represents a portion of the associated image frame, and at least some of the image crops form at least a portion of training data for a machine learning model. The at least one processing device is also configured to perform redundancy reduction to at least one of (i) identify a subset of the image frames from which the image crops are generated and (ii) identify a subset of the image crops for inclusion in the training data.

In a third embodiment, a non-transitory machine readable medium contains instructions that when executed cause at least one processor of an electronic device to obtain multiple image frames and generate multiple image crops of at least one of the image frames. Each image crop represents a portion of the associated image frame, and at least some of the image crops form at least a portion of training data for a machine learning model. The non-transitory machine readable medium also contains instructions that when executed cause the at least one processor to perform redundancy reduction to at least one of (i) identify a subset of the image frames from which the image crops are generated and (ii) identify a subset of the image crops for inclusion in the training data.

Any one or any combination of the following features may be used with the first, second, or third embodiment.

The machine learning model may be trained using the training data.

The redundancy reduction may include at least one of: (i) performing feature extraction to identify extracted features associated with each image frame and clustering the extracted features associated with the image frames into clusters of similar features to identify groups of the image frames; and (ii) performing feature extraction to identify extracted features associated with each image crop and clustering the extracted features associated with the image crops into clusters of similar features to identify groups of the image crops. The extracted features associated with the image frames or the image crops may be clustered using agglomerative clustering of the extracted features.

The redundancy reduction may include at least one of: (i) from the groups of the image frames, selecting one or more image frames from each of at least some of the groups of image frames, the image crops generated using the selected image frames; and (ii) from the groups of the image crops, selecting one or more image crops from each of at least some of the groups of image crops, the selected image crops used to form at least the portion of the training data.

The one or more image frames from each of the at least some of the groups of image frames may be selected by selecting one image frame from each group of image frames. The one or more image crops from each of the at least some of the groups of image crops may be selected by selecting one image crop from each group of image crops.

The one or more image frames from each of the at least some of the groups of image frames may be selected by at least one of: (i) randomly selecting at least one image frame from each of the at least some of the groups of image frames; and (ii) selecting at least one image frame from each of the at least some of the groups of image frames having more detail or sharper features than other image frames. The one or more image crops from each of the at least some of the groups of image crops may be selected by at least one of: (i) randomly selecting at least one image crop from each of the at least some of the groups of image crops; and (ii) selecting at least one image crop from each of the at least some of the groups of image crops having more detail or sharper features than other image crops.

Each group of image frames may include image frames that are more similar in appearance to one another and less similar in appearance to image frames of other groups of image frames. Each group of image crops may include image crops that are more similar in appearance to one another and less similar in appearance to image crops of other groups of image crops.

The multiple image crops may be generated, for each of the at least one of the image frames, by (i) performing saliency map detection to generate a saliency map for the image frame, the saliency map identifying more important regions of the image frame; (ii) identifying key points in the saliency map or the image frame; (iii) identifying a bounding box for each of the key points; (iv) selecting at least one of the bounding boxes; and (v) cropping the image frame based on the at least one selected bounding box to generate at least one image crop for the image frame.

For each of the at least one of the image frames, at least one of the bounding boxes may be selected by (i) for each of the bounding boxes identified for the image frame, determining a mean value of the saliency map within the bounding box and comparing the mean value to a threshold; and (ii) for each of the bounding boxes identified for the image frame having a mean value meeting or exceeding the threshold, performing non-maximum suppression to exclude duplicate bounding boxes. The at least one selected bounding box may remain after the non-maximum suppression is performed.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IOT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example architecture for dataset construction for training machine learning models in accordance with this disclosure;

FIG. 3 illustrates an example process for crop selection in accordance with this disclosure;

FIG. 4 illustrates another example architecture for dataset construction for training machine learning models in accordance with this disclosure;

FIG. 5 illustrates yet another example architecture for dataset construction for training machine learning models in accordance with this disclosure;

FIGS. 6 and 7 illustrate an example process for redundancy reduction in accordance with this disclosure; and

FIG. 8 illustrates an example method for dataset construction for training machine learning models in accordance with this disclosure.

### DETAILED DESCRIPTION

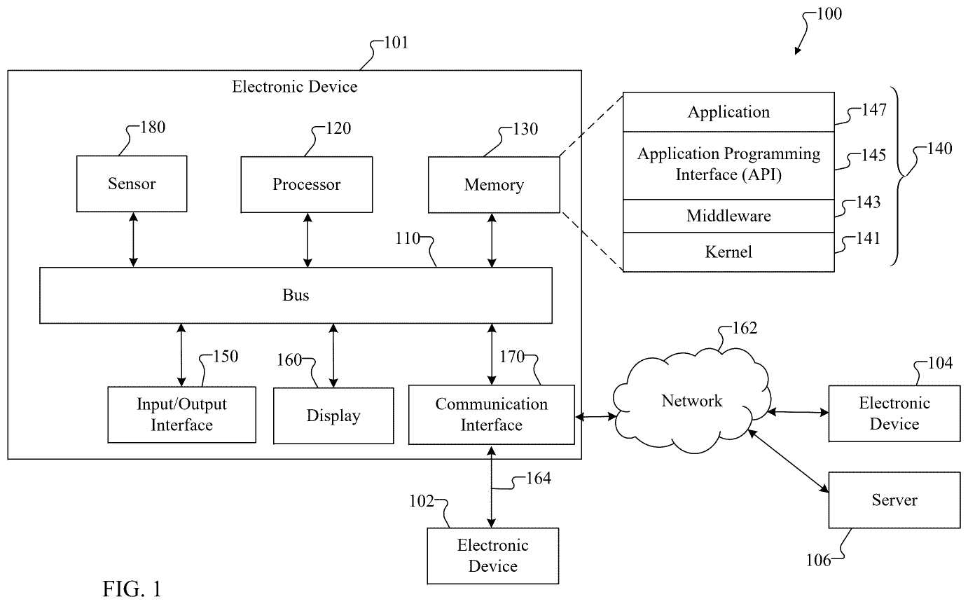

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, training a deep neural network or other machine learning model often involves the use of a large amount of training data. The ability to train machine learning models effectively typically depends on the availability of high-quality diverse training data. Often times, large training datasets are collected by scraping data, such as in the form of images or videos, from the Internet. However, collecting large amounts of training data from such public data sources usually requires significant curation and human intervention. Among other reasons, this is because video recordings and other image sequences often contain redundant images (such as repeated or similar adjacent images) or irrelevant images (such as images with blurred backgrounds or flat images). Also, relevant information tends to be present only in parts of images, so the images often need to be cropped in space as well as in time.

Using redundant or irrelevant images when generating training data can create various problems. For example, the presence of redundant or irrelevant images can result in wasted storage and limit the amount of useful data that can be generated and stored for training purposes. Moreover, the non-uniform spread of information caused by the presence of redundant images can skew the distribution of image samples that are created and used for machine learning model training. A resulting machine learning model can therefore be biased as a result of the rudimentary way in which its training data is collected. Because of this, cleaning up training data generated using images often requires significant amounts of tedious human intervention.

Modern deep learning applications, such as those that involve training of generative artificial intelligence (AI) models, often require huge amounts of training data to be effective. While there has been an increase in the amount of content (particularly video data) being created and made available, the content still needs to be curated and cleaned of redundant and irrelevant data. The quality of any machine learning model for a given task (such as image classification, semantic segmentation, or generative AI) is heavily dependent on its training data. If not trained on diverse and rich datasets, these trained machine learning models can display properties such as bias or overfitting on certain distributions of data.

Some approaches simply attempt to feed all available training data to a machine learning model during training. However, simply providing abundant data (without any cleaning) can slow down the training process significantly. Moreover, this can actually deviate the training of the machine learning model to undesired local minima. In other words, this approach can actually result in a poorly-trained machine learning model that does not operate as expected or desired. In reality, a machine learning model trained using all available training data may actually operate worse than a machine learning model trained using the same training data after curation.

This disclosure provides various techniques supporting dataset construction for training machine learning models. As described in more detail below, multiple image frames can be obtained, such as image frames from one or more videos or other image sequences and/or image frames from one or more datasets. Multiple image crops of at least one of the image frames can be generated, and each image crop can represent a portion of the associated image frame. At least some of the image crops can be used to form at least a portion of training data for a machine learning model. Redundancy reduction can be performed to at least one of (i) identify a subset of the image frames from which the image crops are generated and (ii) identify a subset of the image crops for inclusion in the training data. For instance, the redundancy reduction may limit the image frames from which the image crops are generated (such as by removing image frames that are too similar to other image frames) and/or may discard some of the image crops that are generated (such as by removing image crops that are too similar to other image crops).

In this way, the described techniques can be used to perform dataset construction in order to generate training datasets for use in training machine learning models more effectively. For example, the described techniques can be used to generate collections of image crops in which the image crops are more unique. As a result, a pipeline or other architecture can be used to perform data cleaning in order to obtain improved training datasets, allowing the training datasets to be created in a smarter fashion. For instance, the described techniques can condense large redundant datasets into the most-valuable samples, which can make machine learning model training much more effective and efficient. In some cases, the resulting training datasets may allow trained machine learning models to obtain significantly improved losses, possibly cutting losses by about half or even more.

Note that while various embodiments of this disclosure are described in the context of use with consumer electronic devices (such as smartphones, tablet computers, or televisions), this is merely one example. It will be understood that the principles of this disclosure may be implemented in any number of other suitable contexts and may use any suitable device or devices. Also, note that while some embodiments discussed below are described based on the assumption that one device (such as a server) generates training datasets and performs training of machine learning models that are deployed to other devices (such as consumer electronic devices), this is also merely one example. It will be understood that the principles of this disclosure may be implemented using any number of devices, including different devices that generate training datasets and perform training of machine learning models. In general, this disclosure is not limited to use with any specific type(s) or number(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to dataset construction for training machine learning models. The processor 120 may also or alternatively perform inferencing using one or more machine learning models trained using such datasets.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform dataset construction for training machine learning models and/or perform inferencing using one or more machine learning models trained using such datasets. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to dataset construction for training machine learning models. The server 106 may also or alternatively perform inferencing using one or more machine learning models trained using such datasets.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

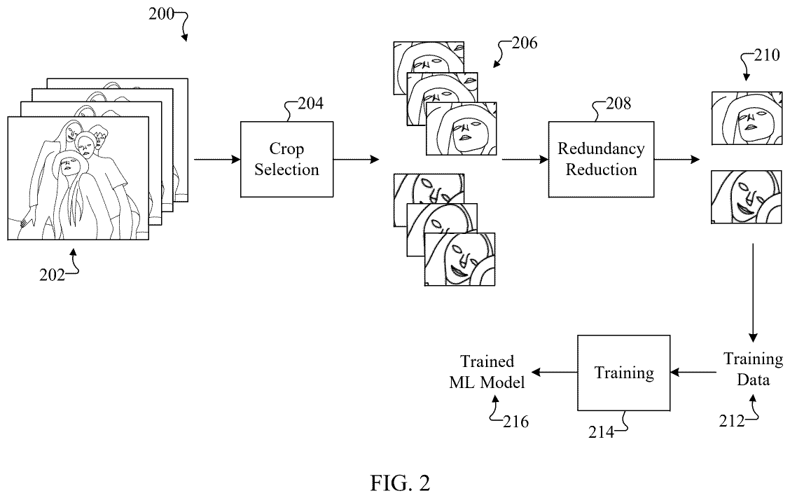

FIG. 2 illustrates an example architecture 200 for dataset construction for training machine learning models in accordance with this disclosure. For case of explanation, the architecture 200 shown in FIG. 2 is described as being implemented using the server 106 in the network configuration 100 shown in FIG. 1. However, the architecture 200 may be implemented using any other suitable device(s) (such as the electronic device 101) and in any other suitable system(s).

As shown in FIG. 2, the architecture 200 receives and processes image frames 202. In some cases, the image frames 202 may include image frames contained in one or more videos or other image sequences and/or image frames contained in one or more large sets of un-curated or other image frames. A sequence of image frames 202 may include image frames captured in rapid succession and may include any suitable number of image frames. A set of un-curated or other image frames may include any suitable number of image frames. The image frames 202 may be obtained from any suitable source(s), such as when the image frames 202 are scraped from the Internet or are included in one or more public or proprietary datasets. Each image frame 202 can have any suitable format, such as a Bayer or other raw image format, a red-green-blue (RGB) image format, or a luma-chroma (YUV) image format. Each image frame 202 can also have any suitable resolution, such as up to fifty megapixels or more. In this particular example, the image frames 202 may represent a sequence of image frames showing people within a given scene. Of course, the contents of the image frames 202 can vary widely based on the circumstances.

A crop selection operation 204 generally operates to process at least one of the image frames 202 and generate image crops 206 based on the image frame(s) 202. Each image crop 206 represents a portion (often a small portion) of the associated image frame 202. For example, in some embodiments, the crop selection operation 204 may, for each of at least one of the image frames 202, perform saliency detection, identify key points, and identify bounding boxes based on the key points. In some cases, each bounding box can have a specified size. The crop selection operation 204 may also process the bounding boxes to select one or more bounding boxes that satisfy one or more criteria, and the selected bounding box(es) can be used to generate one or more image crops 206 for that image frame 202. In this example, the crop selection operation 204 has generated multiple image crops 206 using at least one of the image frames 202, where the multiple image crops 206 include different people's faces. Again, the contents of the image frames 202 can vary widely based on the circumstances, so the contents of the image crops 206 can also vary widely based on the circumstances. Also, the crop selection operation 204 can generate image crops 206 of various other portions of the image frames 202, such as other people's faces in the image frames 202. Among other things, the crop selection operation 204 here can be used to identify patches or other regions of the image frames 202 that could be useful during machine learning model training, while other (possibly irrelevant) areas of the image frames 202 can be ignored.

A redundancy reduction operation 208 generally operates to remove redundant image crops 206 or otherwise select a subset of the image crops 206, leading to the generation of a reduced set of image crops 210. For example, the redundancy reduction operation 208 may cluster the image crops 206 into different groups, where each group includes image crops 206 that are more similar in appearance to each other than to image crops in other groups. The redundancy reduction operation 208 can select one or more image crops 206 in at least some of the groups in order to generate the reduced set of image crops 210. Since each group of image crops 206 contains similar image crops, selecting one or more image crops 210 from different groups helps to ensure that the reduced set of image crops 210 contains more unique or distinct image crops.

The redundancy reduction operation 208 can use any suitable technique(s) to group the image crops 206. For example, in some embodiments, the redundancy reduction operation 208 can perform feature extraction in order to identify relevant features of the image crops 206, and the redundancy reduction operation 208 can perform clustering of the extracted features into clusters. Each cluster of extracted features can represent or be associated with a group of image crops 206 that are more similar in appearance to each other than to the image crops of other groups. In particular embodiments, agglomerative clustering of the extracted features may be used. Agglomerative clustering is a hierarchical-based clustering technique in which individual data items (such as image features) are first clustered by themselves in one level and each subsequent level combines similar clusters from the preceding level while maintaining separation of dissimilar clusters.

The redundancy reduction operation 208 can also use any suitable technique(s) to select image crops 206 from different groups of image crops generated as a result of the clustering for inclusion in a reduced set of image crops 210. For example, in some embodiments, the redundancy reduction operation 208 could select a single image crop 206 from each group or from a subset of the groups, such as in a random manner. In other embodiments, the redundancy reduction operation 208 could select one or more image crops 206 from each group or from a subset of the groups that have more detail or sharper features than other image crops. Note that, if selecting more than one image crop 206 from a group of image crops, the probability of selection of each image crop 206 may be the same, or different probabilities of selection may be used for different image crops 206 in the group. As an example, each image crop 206 may have a probability of selection based on its quality, meaning image crops 206 with higher qualities (such as more detail or sharper features) may have higher probabilities of selection and image crops 206 with lower qualities may have lower probabilities of selection. As another example, even though image crops 206 in a group are all similar, their degree of similarity can still differ. Here, it is possible for image crops 206 in a group that are more similar to each other to have lower probabilities of selection, while more unique image crops 206 in the group could have higher probabilities of selection.

One overall result here is that the redundancy reduction operation 208 reduces or avoids inclusion of image crops in the reduced set of image crops 210 that are redundant or repetitive of one another. Because of this, it is far less likely that the reduced set of image crops 210 will include image crops of the same or substantially the same portions of different image frames 202. Instead, it is far more likely that the reduced set of image crops 210 will include image crops showing unique contents of one or more of the image frames 202. This increases the diversity of the image contents in the reduced set of image crops 210.

The process here can be repeated for any suitable number of image frames 202 of various scenes in order to generate any suitable number of reduced sets of image crops 210, each of which may include any suitable number of image crops. The resulting reduced set(s) of image crops 210 can be used here to create training data 212, which can be used during a training operation 214 to train at least one machine learning (ML) model 216. Note that the specific sets of image crops 210 being generated and the specific machine learning models 216 being trained can vary depending on the use case, such as based on the intended application for the machine learning model(s) 216 being trained. For example, the architecture 200 can be used here to collect data in order to train domain-specific machine learning models 216, such as machine learning models to be used to analyze or process sports recording, movies, or other specific types of video or image contents. The architecture 200 can be used here to collect graphical data (such as user interfaces or games containing structural data) in order to train machine learning models 216 to be used to process graphical data. The architecture 200 can be used here to obtain class-specific data from videos or other image sequences or image frames (such as frames containing human faces) in order to train machine learning models 216 to be used to process image data related to the specific class. In general, the described techniques support training data preparation that can significantly cut down the efforts needed for data preparation (by reducing or avoiding the need to excessively scrutinizing the training data) and can select usable training data from sources like long videos recorded in specific settings.

Although FIG. 2 illustrates one example of an architecture 200 for dataset construction for training machine learning models, various changes may be made to FIG. 2. For example, various components, operations, or functions in FIG. 2 may be combined, further subdivided, replicated, omitted, or rearranged and additional components, operations, or functions may be added according to particular needs. Also, the specific image frames and image crops shown here are examples only and do not limit the scope of this disclosure.

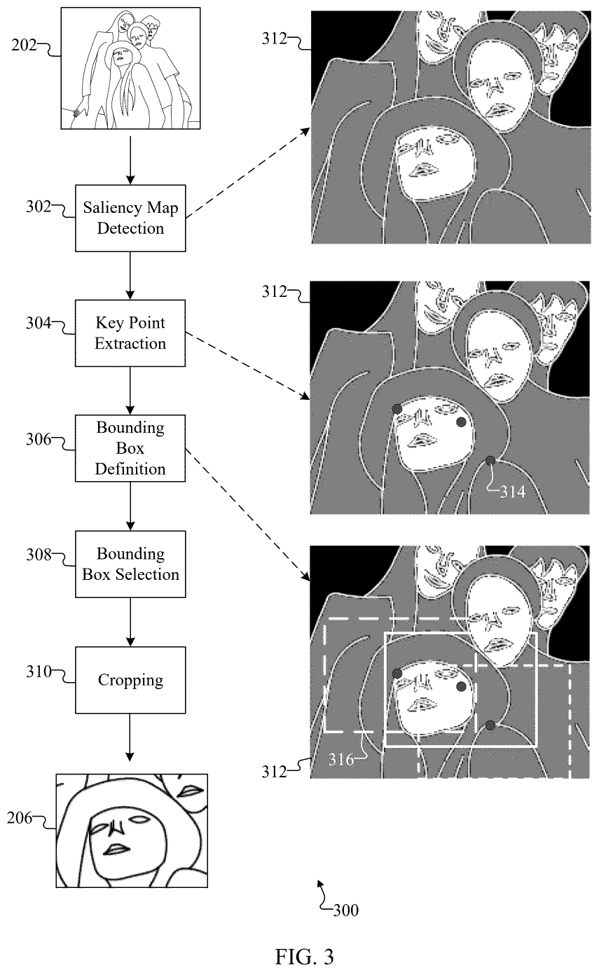

FIG. 3 illustrates an example process 300 for crop selection in accordance with this disclosure. The process 300 may, for example, be performed during or as part of the crop selection operation 204 shown in FIG. 2. For ease of explanation, the process 300 shown in FIG. 3 is described as being implemented using the server 106 in the network configuration 100 shown in FIG. 1. However, the process 300 may be implemented using any other suitable device(s) (such as the electronic device 101) and in any other suitable system(s).

As shown in FIG. 3, an image frame 202 is being processed in order to create at least one image crop 206 from the image frame 202. In this example, the image frame 202 is provided to a saliency map detection function 302, which generally operates to create a saliency map 312 (a portion of which is shown in FIG. 3) for the image frame 202. The saliency map 312 identifies the more important region(s) of the image frame 202. The saliency map detection function 302 can use any suitable technique(s) to generate saliency maps 312 for image frames 202. Various techniques for identifying saliency are known in the art, and additional techniques are sure to be developed in the future. This disclosure is not limited to any specific technique for generating saliency maps. Note that the saliency map 312 in this example includes three values represented by three different types of shadings. However, the saliency map 312 may include values spanning any suitable range of values.

The more important regions of the image frame 202 may be defined based on the task/problem at hand and the image contents that are of interest. For example, if the goal of training dataset generation is to produce image crops having minimum background or out-of-focus areas due to motion blur, the saliency map 312 may be generated by creating an in-focus and out-of-focus blur map, where generally-stationary foreground objects can be represented as in-focus areas of the blur map and the background and any moving objects can be represented as out-focus areas of the blur map. The blur map could be created in any suitable manner, such as by detecting motion areas using discrete cosine transform (DCT) or local binary pattern (LBP)-based techniques. If the goal of training dataset generation is to produce image crops having contents of a particular class (such as people's faces), the saliency map 312 can identify regions with contents of that class as being important and can identify all other contents as being unimportant.

A key point extraction function 304 generally operates to process the image frame 202 and/or the saliency map 312 in order to identify one or more key points within the scene. Examples of potential key points 314 are shown within the saliency map 312 of FIG. 3. The key points 314 can represent certain points of interest within the image frame 202 and/or the saliency map 312. The key point extraction function 304 can use any suitable technique(s) to identify key points 314. Various techniques for identifying key points are known in the art, and additional techniques are sure to be developed in the future. For instance, a Scale Invariant Feature Transform (SIFT)-based approach may be used to identify the key points 314, which can be done independent of properties of the image frame 202 (such as viewpoint, depth, and scale). Other example approaches can include connected components or key point extraction techniques, such as a corner/feature detector (like a Harris corner detector) or a Speeded-Up Robust Feature (SURF)-based approach. This disclosure is not limited to any specific technique for identifying key points.

A bounding box definition function 306 generally operates to create bounding boxes based on the identified key points. Examples of bounding boxes 316 are shown within the saliency map 312 of FIG. 3. In some cases, the bounding boxes 316 may have a common size, such as a size defined as (m, n) (where m is the width and n is the height of the box). Each bounding box 316 may be centered around a different key point 314, although any given bounding box 316 could be repositioned or realigned so that it fits entirely within the image frame 202/saliency map 312. In some embodiments, the number of bounding boxes 316 defined here can depend on the number of identified key points 314.

A bounding box selection function 308 generally operates to select one or more of the bounding boxes 316 for use in generating one or more image crops 206 of the image frame 202. For example, the bounding box selection function 308 may apply one or more selection criteria to the identified bounding boxes 316 in order to select one or more of the bounding boxes 316. In some embodiments, the following two selection criteria may be used. The first selection criterion can involve, for each bounding box 316, determining a mean value of the saliency map 312 within the bounding box 316 and comparing the mean value to a threshold. Each bounding box 316 having a mean value below the threshold can be excluded from further consideration. The second selection criterion can involve, for each bounding box 316 having a mean value meeting or exceeding the threshold, performing non-maximum suppression. Non-maximum suppression refers to a post-processing technique that is used in object detection tasks to eliminate duplicate detections of bounding boxes. Essentially, the non-maximum suppression is performed to exclude duplicate bounding boxes 316, and any remaining bounding box or boxes 316 can be selected for further use. In FIG. 3, for example, only the bounding box 316 shown using solid lines may be selected. The bounding boxes 316 shown using different dashed lines may be excluded. A cropping function 310 applies each bounding box 316 selected by the bounding box selection function 308 to the image frame 202, resulting in the creation of an image crop 206 for each selected bounding box 316.

In some embodiments, a particular implementation of the process 300 may be expressed as follows.

### Algorithm:

| | |
|---|---|
| 1. | Obtain image frame I, where I ∈ [symbol] ^{H × W × 3} |
| 2. | Generate saliency map S, where S ∈ [symbol] ^{H × W} |
| 3. | Extract key points K in saliency map S, where K = {K₁, K₂, ..., Kₚ, ..., K_{P}} and |

each Kₚ = {Kₚₓ, K_{py}}

| 4. | For each key point Kₚ: | |
|---|---|---|
| | a. | Overlay bounding box Bbₚ, where Bbₚ ∈ [symbol] ^{m × n} |
| | | Bbₚ can be represented with points {px_{left}, px_{right}, pyₜₒₚ, py_{bottom}} |
| | | px_{left} = Kₚₓ − m/2, px_{right} = Kₚₓ + m/2 |
| | | pyₜₒₚ = K_{py} − n/2, py_{bottom} = K_{py} + n/2 |
| | b. | Adjust Bbₚ such that: |
| | | px_{left} >= 0, px_{right} <= H |
| | | pyₜₒₚ >= 0, py_{bottom} <= W |

| | |
|---|---|
| 5. | For each Bbₚ run selection criteria 1: |
| | C₁ = { } |
| | For each Bbₚ: |

```
  if mean (S(px_{left} : px_{right}, pyₜₒₚ : py_{bottom})) > T
  then add Bbₚ to C₁
```

| | |
|---|---|
| 6. | Run selection criteria 2: Select Bbₚ based on non-maximum suppression on C₁ |
| | For all Bbₚ in C₁ |

C₂ = non_maximum_suppression(Bb_critera1)

| | |
|---|---|
| 7. | All Bbₚ in C₂ are used to crop image frame I |

Although FIG. 3 illustrates one example of a process 300 for crop selection, various changes may be made to FIG. 3. For example, various components, operations, or functions in FIG. 3 may be combined, further subdivided, replicated, omitted, or rearranged and additional components, operations, or functions may be added according to particular needs. Also, the specific image frame, image crop, saliency map, key points, and bounding boxes are examples only and can vary based on the circumstances.

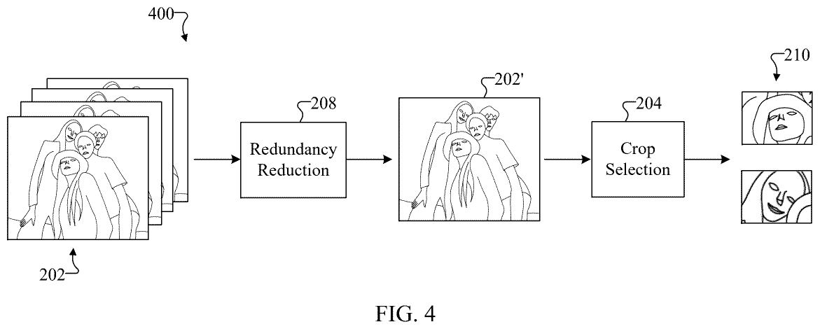

FIG. 4 illustrates another example architecture 400 for dataset construction for training machine learning models in accordance with this disclosure. The architecture 400 shown in FIG. 4 is similar to the architecture 200 shown in FIG. 2. In FIG. 4, however, the order of the crop selection operation 204 and the redundancy reduction operation 208 are reversed. Thus, the redundancy reduction operation 208 here actually operates on the image frames 202 themselves and not on the image crops 206. As a result, the redundancy reduction operation 208 can select at least one of the image frames 202 for output as an image frame 202′. The crop selection operation 204 can generate image crops based on the image frame(s) 202′. Since the number of image frames being cropped has already been reduced, the image crops created by the crop selection operation 204 may represent the reduced set of image crops 210. In this approach, redundancy can be removed from the image frames 202 first, and crop selection can be performed only on the selected subset of image frames 202.

Among other things, this approach can be helpful in reducing the processing load from crop selection. This may be particularly useful when processing image frames 202 having excessively large amounts of redundancy, such as image frames of a high frames-per-second (fps) video sequence. The crop selection operation can involve large amounts of computational power, so reducing the number of image frames being processed can be useful in some circumstances.

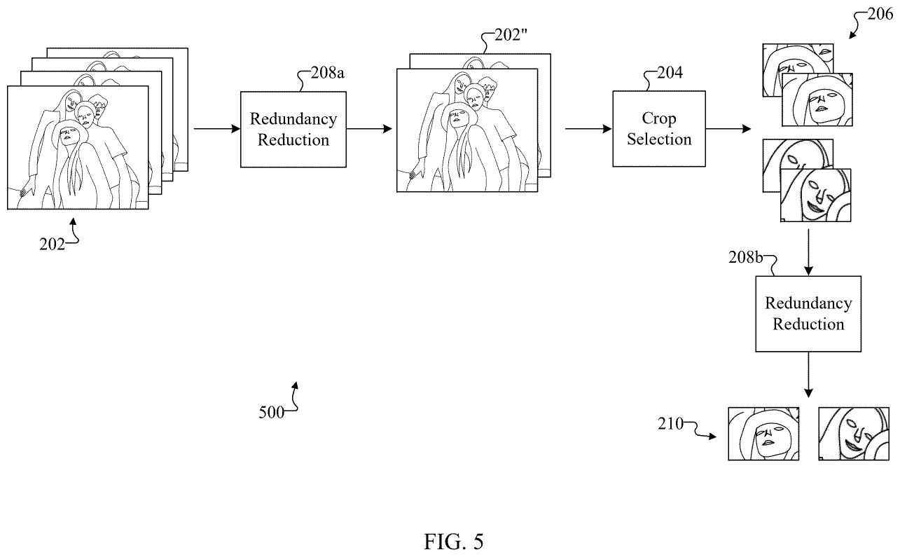

FIG. 5 illustrates yet another example architecture 500 for dataset construction for training machine learning models in accordance with this disclosure. The architecture 500 shown in FIG. 5 represents a combination of the architecture 200 shown in FIG. 2 and the architecture 400 shown in FIG. 4. That is, the image frames 202 can be processed and reduced in number by a first redundancy reduction operation 208a, resulting in the identification of a subset of image frames 202″. The crop selection operation 204 can generate image crops 206 based on the subset of image frames 202″, and a second redundancy reduction operation 208b can process the image crops 206 in order to generate the reduced set of image crops 210.

The approach shown in FIG. 5 allows, for example, image frames 202 with high redundancy to be reduced in the first redundancy reduction stage (the first redundancy reduction operation 208a). In some cases, a threshold used by the first redundancy reduction operation 208a for determining when to keep image frames 202 may be relatively low, which may allow the first redundancy reduction operation 208a to only exclude image frames 202 that are identical or almost identical (meaning they have very high similarity). Crop selection is performed to generate useful image crops 206, and those image crops 206 are processed using the second redundancy reduction stage (the second redundancy reduction operation 208b). This approach also helps in cases with local movement. That is, the first redundancy reduction operation 208a may place different image frames of the same scene but containing motion in separate groups based on the clustering. While this may allow image crops 206 of the different image frames to be generated during crop selection, the second redundancy reduction operation 208b can help to identify and reduce substantially-similar image crops 206.

The architectures 400, 500 shown in FIGS. 4 and 5 can be used to process any suitable number of image frames 202 of various scenes in order to generate any suitable number of reduced sets of image crops 210, each of which may include any suitable number of image crops. While not shown here, the resulting reduced set(s) of image crops 210 can be used to create training data 212, which can be used during the training operation 214 to train at least one machine learning model 216 as discussed above.

Although FIGS. 4 and 5 illustrate other examples of architectures 400 and 500 for dataset construction for training machine learning models, various changes may be made to FIGS. 4 and 5. For example, various components, operations, or functions in each of FIGS. 4 and 5 may be combined, further subdivided, replicated, omitted, or rearranged and additional components, operations, or functions may be added according to particular needs. Also, the specific image frames and image crops shown here are examples only and do not limit the scope of this disclosure.

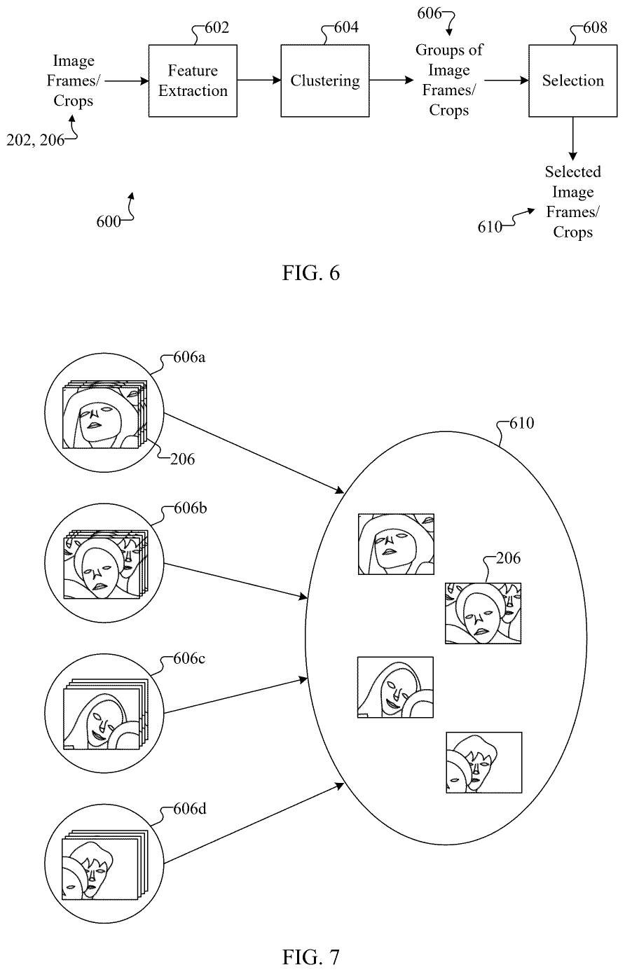

FIGS. 6 and 7 illustrate an example process 600 for redundancy reduction in accordance with this disclosure. The process 600 may, for example, be performed during or as part of the redundancy reduction operations 208, 208a, 208b shown in FIGS. 2, 4, and 5. For case of explanation, the process 600 shown in FIGS. 6 and 7 is described as being implemented using the server 106 in the network configuration 100 shown in FIG. 1. However, the process 600 may be implemented using any other suitable device(s) (such as the electronic device 101) and in any other suitable system(s).

As shown in FIG. 6, the process 600 generally operates to receive and process image frames 202 or image crops 206. Whether image frames 202 or image crops 206 are being received depends on the implementation. For example, in FIG. 2, the redundancy reduction operation 208 would receive image crops 206. In FIG. 4, the redundancy reduction operation 208 would receive image frames 202. In FIG. 5, the redundancy reduction operation 208a would receive image frames 202, and the redundancy reduction operation 208b would receive image crops 206.

A feature extraction operation 602 generally operates to identify and extract relevant features from the image frames 202 or image crops 206. In some cases, the feature extraction operation 602 can represent a trained machine learning model or other logic that is configured to extract certain features from the image frames 202 or image crops 206. The specific features that are extracted can be learned or otherwise identified, such as during training of the feature extraction operation 602. The specific features that are extracted can be expressed in any suitable manner, such as by using fixed-length or other feature vectors. The feature extraction operation 602 can use any suitable technique(s) to extract features. Various techniques for performing feature extraction are known in the art, and additional techniques are sure to be developed in the future. For instance, the feature extraction operation 602 may be implemented using a Contrastive Language Image Pretraining (CLIP) encoder, a VGGNet model, a DenseNet model, or a ResNet50 model. Hand-crafted features, such as those identified using SIFT, SURF, Principal Component Analysis (PCA), or Histogram of Oriented Gradient (HOG), can also be used. This disclosure is not limited to any specific technique for performing feature extraction.

A clustering operation 604 generally operates to cluster the extracted features for the image frames 202 or image crops 206 in order to identify image frames 202 or image crops 206 that are more similar in appearance to each other. Those image frames 202 or image crops 206 can be collected into different groups 606 of image frames or image crops. That is, each group 606 can include image frames or image crops that are more similar in appearance to one another and less similar in appearance to image frames or image crops of other groups 606. Note that not all groups 606 may include multiple image frames 202 or image crops 206. In some circumstances, an image frame 202 or image crop 206 may be substantially different than all other image frames 202 or image crops 206 and therefore be grouped by itself. The clustering operation 604 can use any suitable technique(s) to cluster extracted features. Various techniques for performing data clustering are known in the art, and additional techniques are sure to be developed in the future. For instance, the clustering operation 604 may use an unsupervised learning technique to create clusters so that image frames 202 or image crops 206 with similar features are grouped together. In some embodiments, agglomerative clustering can be used to create hierarchical clusters, where a threshold can be set to create a desired number of clusters. Other clustering techniques that could be used may include K-means clustering, K-nearest neighbors clustering, Density-Based Spatial Clustering of Applications with Noise (DBSCAN), and Mean-Shift clustering. This disclosure is not limited to any specific technique for performing feature clustering.

A selection operation 608 generally operates to select one or more image frames 202 or image crops 206 from each of at least some of the groups 606. Depending on where the redundancy reduction is being performed within the associated architecture, the selection operation 608 may output selected image frames 202 for use during crop selection or output selected image crops 206 for inclusion in training data 212. The selection operation 608 may use any of various techniques to select the image frames 202 or image crops 206 from among the groups 606. For example, the selection operation 608 could select one image frame 202 or image crop 206 from each group 606. The selection operation 608 could randomly select at least one image frame 202 or image crop 206 from each of at least some of the groups 606. The selection operation 608 could select at least one image frame 202 or image crop 206 from each of at least some of the groups 606 having more important features, such as more detail or sharper features, than other image frames 202 or image crops 206 within that group 606. The selection operation 608 could select multiple image frames 202 or image crops 206 from each of at least some of the groups 606, where the image frames 202 or image crops 206 have equal or different probabilities of selection (such as based on their quality and/or similarity to each other). This results in a selected set 610 of image frames 202 or image crops 206, which may represent a selected image frame 202′ or subset of image frames 202″ or represent a reduced set of image crops 210.

One effect of the redundancy reduction here is that the image frames 202 or image crops 206 can be grouped based on similarity, allowing the image frames 202 or image crops 206 to be restructured into groups having similar features. This allows the process to select unique image frames 202 or image crops 206, which allows a dataset of images to be distilled into the most representative and distinctive image frames/image crops from the dataset. Moreover, in some cases, the redundancy reduction may help to prioritize the best and most unique samples from the various groups 606 of image frames 202 or image crops 206.

FIG. 7 illustrates one example of how the process 600 may be performed, where different groups 606a-606d of image crops 206 have been created. Here, the image crops 206 may be produced using crop selection, and clustering can be performed to group the image crops 206 into the different groups 606a-606d. The image crops 206 in each group 606a-606d may be more similar in appearance to each other than to the image crops 206 of other groups. The selection operation 608 may select one or more image crops 206 from each of at least some of the groups 606a-606d in order to create the selected set 610 of image crops 206. In this example, the selected set 610 includes one image crop 206 from each group 606a-606d. The selected image crops 206 here may be randomly selected, selected due to having at least one more important feature (such as more detail or sharper features), selected based on equal or unequal probabilities of selection, or selected in any other suitable manner.

Although FIGS. 6 and 7 illustrate one example of a process 600 for redundancy reduction, various changes may be made to FIGS. 6 and 7. For example, various components, operations, or functions in each of FIGS. 6 and 7 may be combined, further subdivided, replicated, omitted, or rearranged and additional components, operations, or functions may be added according to particular needs. Also, the specific image crops, groups, and selected image crops are examples only and can vary based on the circumstances.

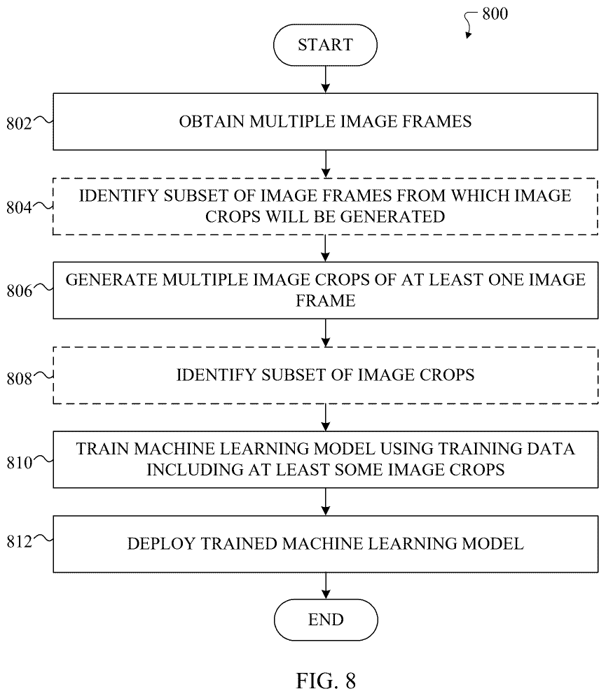

FIG. 8 illustrates an example method 800 for dataset construction for training machine learning models in accordance with this disclosure. For case of explanation, the method 800 shown in FIG. 8 is described as being performed using the server 106 in the network configuration 100 shown in FIG. 1. However, the method 800 may be performed using any other suitable device(s) (such as the electronic device 101) and in any other suitable system(s).

As shown in FIG. 8, image frames are obtained at step 802. This may include, for example, the processor 120 of the server 106 obtaining multiple image frames 202 from one or more datasets, such as when the image frames 202 are scraped from the Internet or are included in one or more public or proprietary datasets. This may also include the processor 120 of the server 106 performing any desired pre-processing of the image frames 202, such as denoising, scaling, or other functions.

A subset of the image frames (from which image crops will be generated) may optionally be identified at step 804. This may include, for example, the processor 120 of the server 106 performing the redundancy reduction operation 208, 208a using the image frames 202 in order to reduce the number of image frames 202. In some cases, the redundancy reduction can be performed by (i) performing feature extraction to identify extracted features associated with each image frame 202, (ii) clustering the extracted features into clusters of similar features to identify groups 606 of the image frames 202 (such as by using agglomerative or other clustering technique), and (iii) selecting one or more image frames 202 from each of at least some of the groups 606. In some cases, one image frame 202 may be selected from each group 606. In other cases, at least one image frame 202 may be randomly selected from each of at least some of the groups 606. In still other cases, at least one image frame 202 from each of at least some of the groups 606 may be selected as having at least one more important feature (such as more detail or sharper features) than other image frames in the group 606. As noted above, the image frames 202 in any given group could have equal or different probabilities of selections. Note, however, that redundancy reduction of the image frames 202 may not be needed, such as when redundancy reduction is performed for image crops.

Multiple image crops of at least one of the image frames are generated at step 806. This may include, for example, the processor 120 of the server 106 performing the crop selection operation 204 to generate image crops 206 from the image frames 202, from a selected image frame 202′, or from a selected subset of image frames 202″. Each image crop 206 represents a portion (often a relatively small portion) of the associated image frame 202. In some cases, the crop selection can be performed for each of at least one of the image frames 202 by (i) performing saliency map detection to generate a saliency map 312 for the image frame 202, where the saliency map 312 identifies more important regions of the image frame 202; (ii) identifying key points 314 in the saliency map 312 or the image frame 202; (iii) identifying a bounding box 316 for each of the key points 314; (iv) selecting at least one of the bounding boxes 316; and (v) cropping the image frame 202 based on the at least one selected bounding box 316 to generate at least one image crop 206 for the image frame 202. At least one of the bounding boxes 316 may, for each of the at least one of the image frames 202, be selected by (i) for each of the bounding boxes 316, determining a mean value of the saliency map 312 within the bounding box 316 and comparing the mean value to a threshold and (ii) for each of the bounding boxes 316 having a mean value meeting or exceeding the threshold, performing non-maximum suppression to exclude duplicate bounding boxes, where the at least one selected bounding box 316 remains after the non-maximum suppression is performed.

A subset of the generated image crops may optionally be identified at step 808. This may include, for example, the processor 120 of the server 106 performing the redundancy reduction operation 208, 208b using the image crops 206 in order to reduce the number of image crops 206. In some cases, the redundancy reduction can be performed by (i) performing feature extraction to identify extracted features associated with each image crop 206, (ii) clustering the extracted features into clusters of similar features to identify groups 606 of the image crops 206 (such as by using agglomerative or other clustering technique), and (iii) selecting one or more image crops 206 from each of at least some of the groups 606. In some cases, one image crop 206 may be selected from each group 606. In other cases, at least one image crop 206 may be randomly selected from each of at least some of the groups 606. In still other cases, at least one image crop 206 from each of at least some of the groups 606 may be selected as having at least one more important feature (such as more detail or sharper features) than other image crops in the group 606. As noted above, the image crops 206 in any given group could have equal or different probabilities of selections. Note, however, that redundancy reduction of the image crops 206 may not be needed, such as when redundancy reduction is performed for image frames. Here, the image crops 206 (or at least the remaining subset of image crops 206) can be used to form at least a portion of training data 212.

At least one machine learning model may be trained using the training data at step 810. This may include, for example, the processor 120 of the server 106 performing the training operation 214 to train at least one machine learning model 216 using the training data that includes the image crops 206 or the remaining subset of image crops 206. Note that various techniques for training machine learning models are known in the art, and additional techniques are sure to be developed in the future. This disclosure is not limited to any specific technique for training a machine learning model. The at least one trained machine learning model is deployed at step 812. This may include, for example, the processor 120 of the server 106 providing the trained machine learning model 216 to one or more other devices (such as another server 106 or electronic device 101) for use during inferencing. This may also or alternatively include the processor 120 of the server 106 performing inferencing itself using the trained machine learning model 216.

Although FIG. 8 illustrates one example of a method 800 for dataset construction for training machine learning models, various changes may be made to FIG. 8. For example, while shown as a series of steps, various steps in FIG. 8 may overlap, occur in parallel, occur in a different order, or occur any number of times (including zero times).

It should be noted that the functions shown in or described with respect to FIGS. 2 through 8 can be implemented in an electronic device 101, 102, 104, server 106, or other device(s) in any suitable manner. For example, in some embodiments, at least some of the functions shown in or described with respect to FIGS. 2 through 8 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 8 can be implemented or supported using dedicated hardware components. In general, the functions shown in or described with respect to FIGS. 2 through 8 can be performed using any suitable hardware or any suitable combination of hardware and software/firmware instructions. Also, the functions shown in or described with respect to FIGS. 2 through 8 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple image frames;
generating, using the at least one processing device, multiple image crops of at least one of the image frames, each image crop representing a portion of the associated image frame, wherein at least some of the image crops form at least a portion of training data for a machine learning model; and
performing, using the at least one processing device, redundancy reduction to at least one of:
identify a subset of the image frames from which the image crops are generated; and
identify a subset of the image crops for inclusion in the training data.

2. The method of claim 1, further comprising:
training the machine learning model using the training data.

3. The method of claim 1, wherein performing the redundancy reduction comprises at least one of:
performing feature extraction to identify extracted features associated with each image frame and clustering the extracted features associated with the image frames into clusters of similar features to identify groups of the image frames; and
performing feature extraction to identify extracted features associated with each image crop and clustering the extracted features associated with the image crops into clusters of similar features to identify groups of the image crops.

4. The method of claim 3, wherein the extracted features associated with the image frames or the image crops are clustered using agglomerative clustering of the extracted features.

5. The method of claim 3, wherein performing the redundancy reduction further comprises at least one of:
from the groups of the image frames, selecting one or more image frames from each of at least some of the groups of image frames, the image crops generated using the selected image frames; and
from the groups of the image crops, selecting one or more image crops from each of at least some of the groups of image crops, the selected image crops used to form at least the portion of the training data.

6. The method of claim 5, wherein at least one of:
selecting the one or more image frames from each of the at least some of the groups of image frames comprises selecting one image frame from each group of image frames; and
selecting the one or more image crops from each of the at least some of the groups of image crops comprises selecting one image crop from each group of image crops.

7. The method of claim 5, wherein at least one of:
selecting the one or more image frames from each of the at least some of the groups of image frames comprises at least one of:
randomly selecting at least one image frame from each of the at least some of the groups of image frames; and
selecting at least one image frame from each of the at least some of the groups of image frames having more detail or sharper features than other image frames; and
selecting the one or more image crops from each of the at least some of the groups of image crops comprises at least one of:
randomly selecting at least one image crop from each of the at least some of the groups of image crops; and
selecting at least one image crop from each of the at least some of the groups of image crops having more detail or sharper features than other image crops.

8. The method of claim 3, wherein at least one of:
each group of image frames includes image frames that are more similar in appearance to one another and less similar in appearance to image frames of other groups of image frames; and
each group of image crops includes image crops that are more similar in appearance to one another and less similar in appearance to image crops of other groups of image crops.

9. The method of claim 1, wherein generating the multiple image crops comprises, for each of the at least one of the image frames:
performing saliency map detection to generate a saliency map for the image frame, the saliency map identifying more important regions of the image frame;
identifying key points in the saliency map or the image frame;
identifying a bounding box for each of the key points;
selecting at least one of the bounding boxes; and
cropping the image frame based on the at least one selected bounding box to generate at least one image crop for the image frame.

10. The method of claim 9, wherein, for each of the at least one of the image frames, selecting at least one of the bounding boxes comprises:
for each of the bounding boxes identified for the image frame, determining a mean value of the saliency map within the bounding box and comparing the mean value to a threshold; and
for each of the bounding boxes identified for the image frame having a mean value meeting or exceeding the threshold, performing non-maximum suppression to exclude duplicate bounding boxes;
wherein the at least one selected bounding box remains after the non-maximum suppression is performed.

11. An apparatus comprising:
at least one processing device configured to:
obtain multiple image frames;
generate multiple image crops of at least one of the image frames, each image crop representing a portion of the associated image frame, wherein at least some of the image crops form at least a portion of training data for a machine learning model; and
perform redundancy reduction to at least one of:
identify a subset of the image frames from which the image crops are generated; and
identify a subset of the image crops for inclusion in the training data.

12. The apparatus of claim 11, wherein, to perform the redundancy reduction, the at least one processing device is configured to at least one of:
perform feature extraction to identify extracted features associated with each image frame and cluster the extracted features associated with the image frames into clusters of similar features to identify groups of the image frames; and
perform feature extraction to identify extracted features associated with each image crop and cluster the extracted features associated with the image crops into clusters of similar features to identify groups of the image crops.

13. The apparatus of claim 12, wherein the at least one processing device is configured to cluster the extracted features associated with the image frames or the image crops using agglomerative clustering of the extracted features.

14. The apparatus of claim 12, wherein, to perform the redundancy reduction, the at least one processing device is further configured to at least one of:
from the groups of the image frames, select one or more image frames from each of at least some of the groups of image frames, the image crops generated using the selected image frames; and
from the groups of the image crops, select one or more image crops from each of at least some of the groups of image crops, the selected image crops used to form at least the portion of the training data.

15. The apparatus of claim 14, wherein at least one of:
the at least one processing device is configured to select one image frame from each group of image frames; and
the at least one processing device is configured to select one image crop from each group of image crops.

16. The apparatus of claim 14, wherein:
to select the one or more image frames from each of the at least some of the groups of image frames, the at least one processing device is configured to at least one of:
randomly select at least one image frame from each of the at least some of the groups of image frames; and
select at least one image frame from each of the at least some of the groups of image frames having more detail or sharper features than other image frames; and
to select the one or more image crops from each of the at least some of the groups of image crops, the at least one processing device is configured to at least one of:
randomly select at least one image crop from each of the at least some of the groups of image crops; and
select at least one image crop from each of the at least some of the groups of image crops having more detail or sharper features than other image crops.

17. The apparatus of claim 12, wherein at least one of:
each group of image frames includes image frames that are more similar in appearance to one another and less similar in appearance to image frames of other groups of image frames; and
each group of image crops includes image crops that are more similar in appearance to one another and less similar in appearance to image crops of other groups of image crops.

18. The apparatus of claim 11, wherein, to generate the multiple image crops, the at least one processing device is configured, for each of the at least one of the image frames, to:
perform saliency map detection to generate a saliency map for the image frame, the saliency map identifying more important regions of the image frame;
identify key points in the saliency map or the image frame;
identify a bounding box for each of the key points;
select at least one of the bounding boxes; and
crop the image frame based on the at least one selected bounding box to generate at least one image crop for the image frame.

19. The apparatus of claim 18, wherein, for each of the at least one of the image frames, to select at least one of the bounding boxes, the at least one processing device is configured to:
for each of the bounding boxes identified for the image frame, determine a mean value of the saliency map within the bounding box and compare the mean value to a threshold; and
for each of the bounding boxes identified for the image frame having a mean value meeting or exceeding the threshold, perform non-maximum suppression to exclude duplicate bounding boxes;
wherein the at least one selected bounding box remains after the non-maximum suppression is performed.

20. A non-transitory machine readable medium containing instructions that when executed cause at least one processor of an electronic device to:
obtain multiple image frames;
generate multiple image crops of at least one of the image frames, each image crop representing a portion of the associated image frame, wherein at least some of the image crops form at least a portion of training data for a machine learning model; and
perform redundancy reduction to at least one of:
identify a subset of the image frames from which the image crops are generated; and
identify a subset of the image crops for inclusion in the training data.
